(19) United States
(12) Patent Application Publication
(10) Pub. No.: US 2007/0300165 A1
(43) Pub. Date: Dec. 27, 2007

(54) USER INTERFACE FOR SUB-CONFERENCING

(75) Inventor: Aliasgar Haveliwala, Sammamish, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Corporation in the State of Washington, Redmond, WA (US)

(21) Appl. No.: 11/561,409

(22) Filed: Nov. 19, 2006

Related U.S. Application Data
(60) Provisional application No. 60/805,850, filed on Jun. 26, 2006.

(51) Int. Cl. G06F 3/00; G06F 3/048

(52) U.S. Cl. 715/758; 715/810; 715/753

(57) ABSTRACT

The present breakout room technique provides breakout rooms, or smaller sub-sets of a larger meeting, with full collaboration capabilities in live web-based conferencing applications. It provides for the capability to easily create sub-meetings or breakout rooms and the ability to assign individuals to breakout rooms. It provides a seamless experience in joining into breakout rooms with audio provisioning. The present breakout room technique also seamlessly brings back breakout room attendees to the main room with audio provisioning. Furthermore, it provides the ability for the instructor to roam between rooms, the ability to assign content to breakout rooms, and the ability to review content from breakout rooms in the main room. It also provides a transition screen to let meeting attendees know they are being transitioned from the main meetings to sub-meetings, and back.

This application claims priority under 35 U.S.C. Section 119(e)(1) of provisional application No. 60/805,850, filed Jun. 26, 2006 and entitled “FULL COLLABORATION BREAKOUT ROOMS FOR CONFERENCING”.

### BACKGROUND

Web conferencing has become more and more popular thanks to the emergence of high speed Internet and reduced prices of high quality web cameras. Live web meetings are increasingly used to deliver training within an organization. Simulating the class room environment using web conferencing has been a key demand from instructors and students alike.

Being able to create subgroups for collaboration is desirable in various types of web conferencing or training environments. Such subgroups allow students to work at different levels or create working groups to collaborate on projects. Scheduling of subgroups for web meetings often involves manual scheduling of numerous sub-meetings, however, which is time consuming and cumbersome. Additionally, this manual scheduling often precludes the spontaneous creation of such sub-meetings, sometimes referred to as breakout rooms.

### SUMMARY

The present breakout room technique provides breakout rooms (i.e., smaller sub-sets of a larger meeting) with full collaboration capabilities in live web-based conferencing applications. Thus, the scope of the main room is truly sub-scoped into a sub-conference with data, audio and video sub-conferences for each individual breakout room.

The present breakout room technique provides for the capability to easily create breakout rooms and the ability to assign individuals to breakout rooms. It provides a seamless experience in joining into breakout rooms with audio provisioning. The present breakout room technique eliminates the disjointed process faced by a training instructor using a live web meeting that involves manual scheduling of different meetings and manual communication of audio options for each meeting. The present breakout room technique also seamlessly brings back breakout room attendees to the main room with audio provisioning. Furthermore, it provides the ability for the instructor to roam between rooms, assign content to breakout rooms, and to review content from breakout rooms in the main room. It also provides the ability for students to ask questions, ask for help, or chat with the instructors.

The present breakout room technique also provides a UI that allows meeting room management and control from an attendee pane. Room management is integrated into the attendee roster and content areas. No explicit content copying or moving by students or instructors to the main conference is necessary. Additionally, transition curtain and attendee orientation effects are used to reflect a breakout room state when transitioning from the main room.

It is noted that while the foregoing limitations in existing techniques for overcoming web conferencing issues described in the Background section can be resolved by a particular implementation of the present breakout room technique described herein, this technique is in no way limited to implementations that just solve any or all of the noted disadvantages. Rather, the present technique has a much wider application as will become evident from the descriptions to follow.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

The specific features, aspects, and advantages of the disclosure will become better understood with regard to the following description, appended claims, and accompanying drawings where:

FIG. 1 is a diagram depicting a general purpose computing device constituting an exemplary system for a implementing a component of the present breakout room technique.

FIG. 2 is a diagram depicting a high level system architecture and environment employed in the present breakout room technique.

FIG. 3 is a diagram depicting a high level system architecture and environment employed in the present breakout room technique wherein multiple clients are shown.

FIG. 4 is a flow diagram of one exemplary embodiment of the breakout room process wherein a meeting is scheduled and conducted.

FIG. 5 is a flow diagram of one exemplary embodiment of the breakout room process wherein breakout rooms are set up from a main meeting.

FIG. 6 is an exemplary user interface wherein the present breakout room technique is controlled from an attendee pane.

FIG. 7 is an exemplary user interface showing the attendee pane of the present breakout room technique.

FIG. 8 is an exemplary user interface showing the content pane of the present breakout room technique.

FIG. 9 is a flow diagram of one exemplary embodiment of the breakout room process wherein a breakout rooms are launched.

FIG. 10 is an exemplary user interface showing a transition screen when attendees are transitioned from the main room to breakout rooms in the present breakout room technique.

FIG. 11 is a flow diagram of one exemplary embodiment of the breakout room process wherein a breakout rooms are stopped.

### DETAILED DESCRIPTION

In the following description, reference is made to the accompanying drawings that form a part hereof, and in which is shown by way of illustration specific embodiments in which the invention may be practiced. It is understood that other embodiments may be utilized and structural changes may be made without departing from the scope of the present disclosure.

### 1.0 The Computing Environment.

Before providing a description of embodiments of the present full collaboration breakout room technique, a brief, general description of a suitable computing environment in which portions of the technique may be implemented will be described. The technique is operational with numerous general purpose or special purpose computing system environments or configurations. Examples of well known computing systems, environments, and/or configurations that may be suitable for use with the process include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

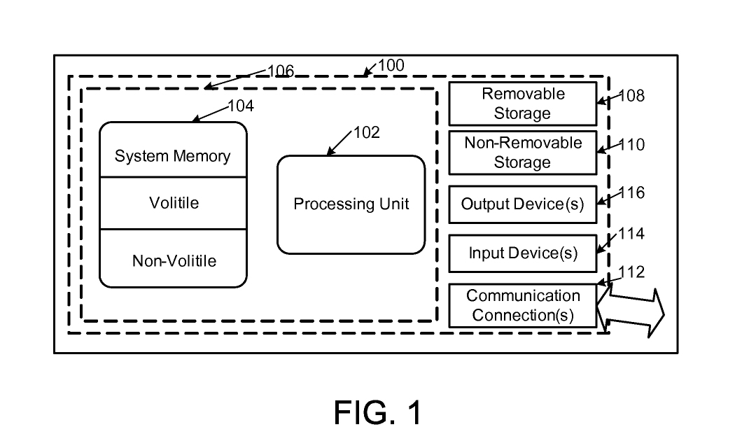

FIG. 1 illustrates an example of a suitable computing system environment. The computing system environment is only one example of a suitable computing environment and is not intended to suggest any limitation as to the scope of use or functionality of the present system and process. Neither should the computing environment be interpreted as having any dependency or requirement relating to any one or combination of components illustrated in the exemplary operating environment. With reference to FIG. 1, an exemplary system for implementing the present process includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Device 100 may also contain communications connection(s) 112 that allow the device to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 100 may also have input device(s) 114 such as keyboard, mouse, camera, microphone, pen, voice input device, touch input device, etc. In particular, such input device may include a video camera and/or a web camera. Output device(s) 116 such as a display, speakers, printer, etc. may also be included. All these devices are well known in the art and need not be discussed at length here.

The present technique may be described in the general context of computer-executable instructions, such as program modules, being executed by a computing device. Generally, program modules include routines, programs, objects, components, data structures, and so on that perform particular tasks or implement particular abstract data types. The process may also be practiced in distributed computing environments where tasks are performed by remote processing devices that are linked through a communications network. In a distributed computing environment, program modules may be located in both local and remote computer storage media including memory storage devices.

The exemplary operating environment having now been discussed, the remaining parts of this description section will be devoted to a description of the program modules embodying the present breakout room technique.

### 2.0 Full Collaboration Breakout Rooms.

### 2.1 Overview.

The present full collaboration breakout room technique provides breakout rooms with full collaboration capabilities in live web-based conferencing applications. That is, a main conference is truly sub-scoped into sub-conferences with data, audio and video sub-conferenced for each individual breakout room.

### 2.2 Environment and Architecture.

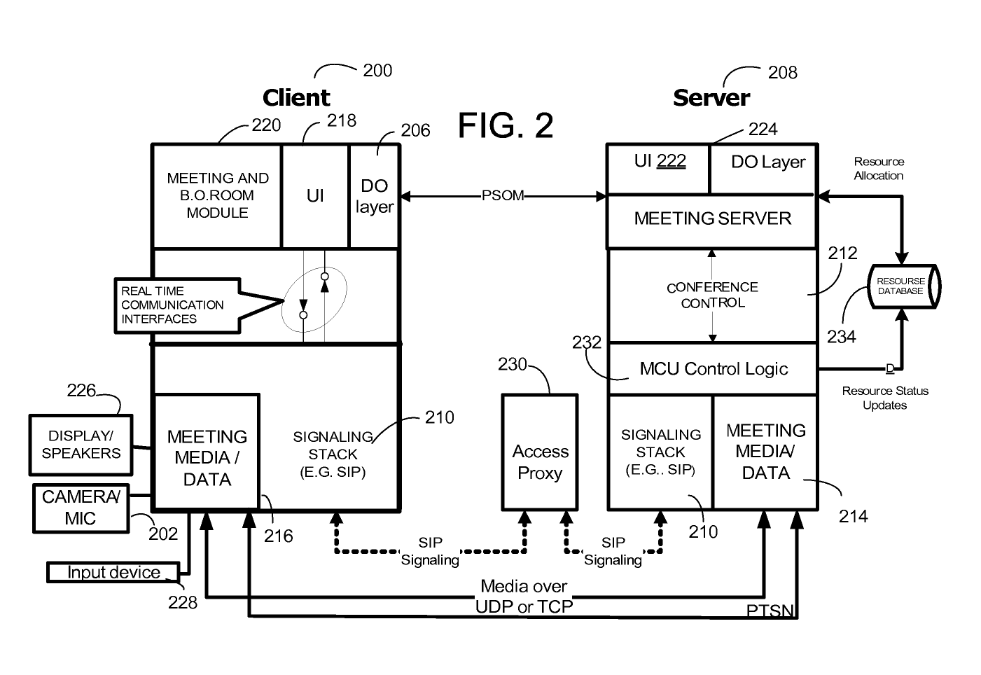

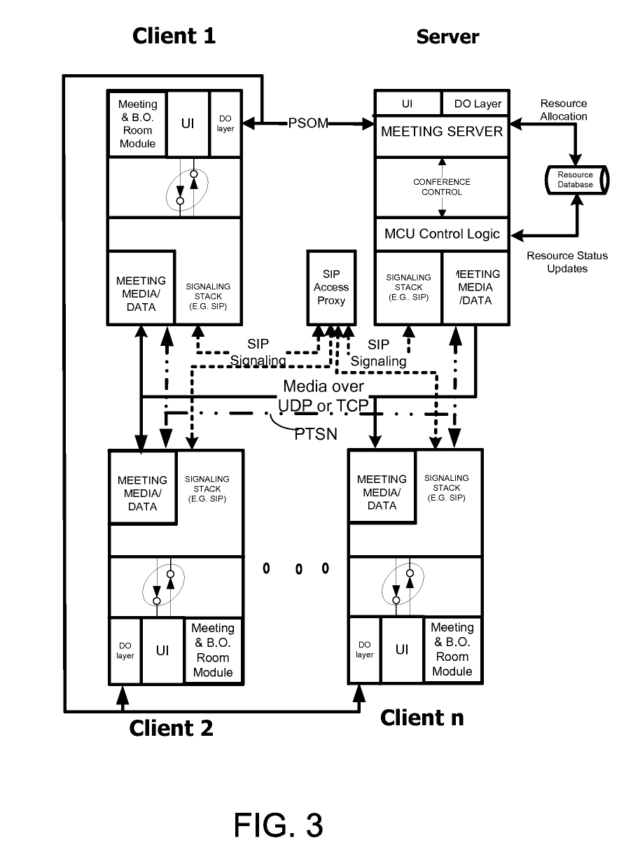

FIGS. 2 and 3 provide exemplary environments wherein the present breakout room technique can be practiced. Various client and server components interact over a network, such as for example the Internet or an intranet, for the present breakout room technique. Additionally, these components can also be connected to a Public Switched Telephone Service (PTSN).

2.2.1 One or more clients—The present breakout room technique includes one or more client(s) 200 that participate in a web meeting, conference or training session. These one or more clients 200 receive audio/visual (A/V) data from any local A/V source (e.g., camera and/or microphone 202) and can send this A/V data over a network 204. In one embodiment, there is a distributed object (DO) layer 206 which abstracts the signaling transactions 210 between the client 200 and a meeting server 208. Similarly, conference control 212 and media transactions 214, 216 between the client 200 and the server 208 may be abstracted, as will be known by those skilled in the art. The module for setting up and executing a meeting and managing the creation and use of breakout rooms, as well as modules sending and receiving meeting data, video and audio, are built on top of these infrastructure pieces. The meeting and breakout room functionality operates to allow a client to be configured as an instructor/presenter or a student/attendee. The present breakout room technique also includes a User Interface (UI) layer 218 at the client 200 that allows set up, control and display of the system and data. The client can also process integrated audio such as Voice over Internet Protocol (VOIP) and Public System Telephone Network (PSTN).

The client 200 includes a meeting and breakout room module 220 and receives audio/visual data from any audio/video source, such as a conventional web camera/microphone 202. The client renders the audio/video on a display with speakers 226 (or a display and separate speaker) and also has an input device 228 such as a keyboard or mouse. The client also has a module for receiving and storing various real-time communication (RTC) and meeting media and data 216 and a module 210 for communicating with a meeting server 208. In one embodiment, the meeting server communicates with the client typically via a SIP protocol via an Access Proxy 230 which interfaces with a signaling stack 210 at the meeting server 208 that includes the server entities. The Session Initiation Protocol (SIP) is an application-layer control (signaling) protocol for creating, modifying, and terminating sessions with one or more participants. These sessions typically include Internet telephone calls, multimedia distribution, and multimedia conferences. It is widely used as signaling protocol for Voice over IP, along with H.323 and others. Alternately the communication between the client and the meeting service server preferably takes place via Persistent Shared Object Model (PSOM) protocol, a protocol used to communicate with different objects, via a Data Object layer 206. The client's user interface (UI) control takes place via a UI control module 218. The clients and the server can also be connected to the PTSN 236.

2.2.2 A meeting server—The present breakout room technique includes a server 208 that hosts the meeting over a client-server network 204. The meeting server also includes a UI layer 222 for setting up the meeting and for receiving, sending, rendering video streams etc. and related notifications. The meeting server 208 also includes a meeting and breakout room module 224, and includes a Media Control Unit (MCU) 232 which keeps track of incoming media and meeting data in a media stack 214 and the status of the meeting participants via a control module 212 and a resource database 234 in order to control the meeting.

The above discussed configuration can be extended to many clients as shown in FIG. 3, which can operate as instructors/presenters or students. It should be noted that other client-server configurations could also be used to practice the present breakout room technique.

### 2.3 Terminology

The following terminology may be useful in describing the present breakout room technique:

1) Main Room: Meetings or training sessions begin in a main room, where one or more instructors (or presenters) are teaching a group of students. Instructional activity for the entire audience typically happens from the main room.

2) Breakout Room: During the course of the meeting or training session, the instructor (or presenter) may want to split the attendees into smaller groups. These groups are assigned to a breakout room where they can interact and work with each other. These rooms are preferably terminated by the instructor when its time to bring back the attendees to the main room

3) Instructor/Presenter: The instructor/presenter has a higher level of privileges than the student/attendees. He or she generally sets up the meeting, creates the breakout rooms, assigns the attendees to them, manages the breakout rooms and terminates them. The instructor/presenter can also upload documents and other meeting data to the main room and the breakout rooms.

4) Students/Attendees: Students/attendees do not have the same level of privileges as the instructor/presenter. They generally listen to the instructor, are assigned to breakout rooms and work in groups in the breakout room session. They can create and work on documents in breakout rooms. They generally return to the main room when the instructor terminates the breakout room session.

### 2.4 Functionality

The following paragraphs provide a more detailed description of the present breakout room technique.

### 2.4.1 Overview of a Meeting/Training Session with Breakout Rooms

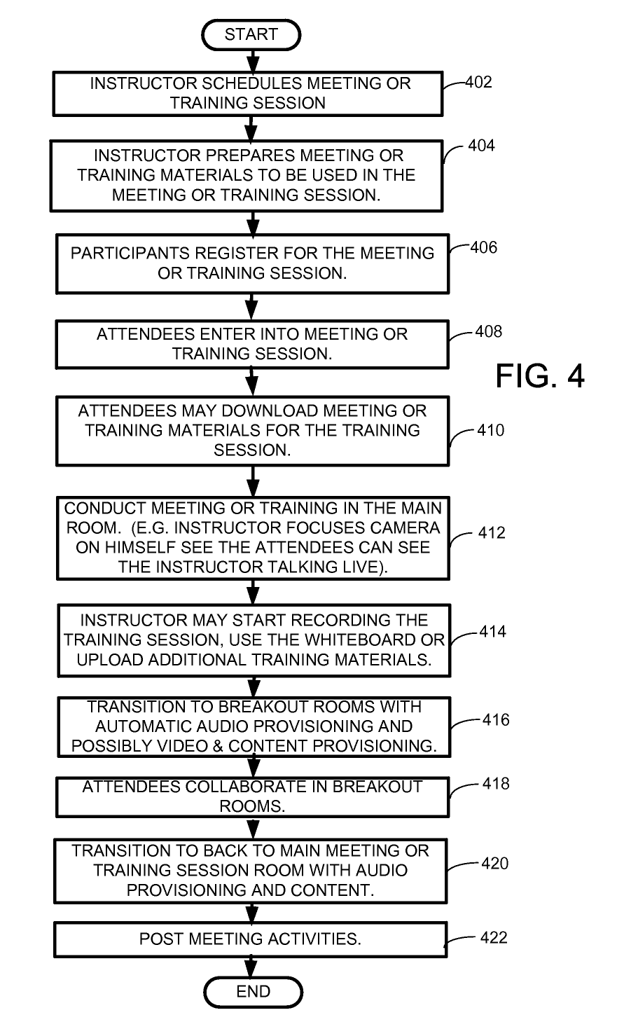

An overview of a one embodiment of the process of conducting a meeting using the present breakout room technique is shown in FIG. 4. As shown in process action 402, an instructor schedules the training session or meeting. The instructor also typically prepares or acquires any training documents to be used in the meeting or training session (process action 404). Meeting attendees/participants then register for the training session or meeting (process action 406). Once the time for the meeting arrives, the meeting attendees enter into the meeting or training session (process action 408). Attendees may download training materials for the training session (process action 410). The instructor conducts the meeting in the main room (e.g., focuses the camera on himself, so the attendees can see him talking live) (process action 412). The instructor may start recording the meeting or training session, use the whiteboard, or upload additional training materials during the meeting in the main meeting rooms (process action 414). The instructor may transition the training session or meeting to one or more breakout rooms with automatic audio provisioning, and video and content provisioning if desired (process action 416). The meeting attendees will then collaborate and interact in their respective breakout rooms (process action 418), until they are transitioned back to the main room by the instructor (process action 420). Then post meeting activities can take place (process action 422).

The following paragraphs provide additional details with respect to the process shown in FIG. 4.

### 2.4.2 E: Learning: Pre-Meeting

In one working embodiment, the user flow for the pre-meeting time frame in an E-learning environment are provided in the paragraphs below.

Schedule a training session (instructor/organizer activity) The instructor (organizer) sets up, organizes and schedules the training session, as is shown in process action 402. To do this the instructor/organizer creates an event. Typical actions taken to create an event include setting registration approval options (e.g., to auto or manual); creating a schedule (one time or recurring) for the event; adding event demographics to be collected from the registrants; preparing pre- and post-meeting survey questions to be answered by the registrants; and setting event notifications to be sent to users (cancellation, acceptance, reminder). Other actions that can be taken to schedule a training event include setting messages for event registration (for example, thank you, sorry, welcome); and publishing the event (publishing the event creates a unique registration page for that event that users are then sent to register for that event) which includes opening it up for registration and sending email invitations to users.

Meeting preparation (instructor/organizer activity) The instructor or organizer also prepares for the meeting or training session, as shown in process action 404. This includes activities like preparing content for the training session or meeting using applications, application sharing, multimedia, video and white board capabilities. The instructor can also prepare tests and answer keys, and set audio options for the main room and breakout rooms. In one embodiment, the audio options are preferably set to PSTN for the main room and 2-way VOIP for breakout rooms or PSTN only. The PSTN numbers can be separately defined for breakout rooms. Alternately, VOIP only audio could be used for both the main room and breakout rooms. The instructor can also specify the number of breakout rooms desired, and audio configuration to be used for the breakout rooms, and set up the main room with the content to be used. The instructor can also assign content to each breakout room.

Registration (Instructor/organizer) During the registration process, as shown in process action 406, the instructor checks for registered participants (who is attending, details of registrant, survey responses) and checks for pending approvals for registration and accepts/deny their request.

Registration (participants) As shown in process action 406, the attendees (participants) register for the event and can complete pre-requisites. In one embodiment an attendee clicks on the URL of an email invitation or notification sent from the meeting server to register and fill in registration information. The attendee can also download any training material required to be completed prior to attending the training session.

### 2.4.3 E-Learning: In-meeting

During the meeting, one instructor delivers the virtual session with the attendees participating remotely. In one embodiment, multiple instructors are possible, but only one is active at a time. Participants/attendees have access to a computer with a network connection and join from their own desktops using any operating system. Network bandwidth from the attendees may vary (modem speed, ISDN, cable/DSL, T1). Meetings can range from one way web-cast style presentations to fully interactive hands-on training sessions. Attendees many communicate with the instructor or other participants via VOIP or on the PTSN.

In one embodiment, the user flow for the in-meeting time frame encompasses the following tasks and activities. The attendees enter into training session from an event registration page provided by the meeting server (process action 408). Attendees may also download meeting content made available for the session (process action 410). The instructor conducts the meeting in the main room, for example, focusing a web cam or other network camera on himself so that attendees can see and hear the instructor talking live (process action 412). The instructor may also lock the session to prevent late attendees from joining the session. The instructor may also set up recording for the session (process action 414). In one embodiment, recording is only made for the main session. Breakout room sessions are not recorded. The instructor uses content to deliver the training session. The instructor may also occasionally use a physical white board and use a video whiteboard feature. The instructor may upload additional course content available for attendees to download during the class meeting. The instructor may mark content to be available in breakout rooms and splits attendees into breakout rooms (process action 416). Audio is automatically provisioned for the breakout room. Attendees disconnect from main room and are transitioned to the audio for the breakout room. Video corresponding to the audio may also be available. Recording in main room pauses when breakout rooms are active. The instructor monitors breakout rooms and roams the rooms to help in any breakout sessions or watch progress. Attendees may use white board, text slides, presentations or video whiteboard in the breakout rooms. The instructor can communicate with one or more individuals in a breakout room. Attendees have the ability to raise their hand for help from the instructor or ask questions in the main room or breakout room. At the completion of the breakout room session, the instructor rolls up breakout rooms back into the main room, as shown in process action 420. Breakout room content that has changed is available in the main room. Attendees are automatically disconnected from their breakout rooms and transitioned to the audio channel for the main room. Recording in main room resumes once breakout rooms are inactive. Attendees can present their results from the breakout room sessions. The instructor can administer tests to attendees. The instructor can set a timer for completing the test that is visible as a counter on the console. The instructor can terminate the test and review the test with the attendees and answers questions. Attendees can see their individual scores for the test taken. User tracking of course completion and testing results may be performed by the instructor or organization.

### 2.4.4 E-Learning: Post Meeting

In one embodiment, the user flow for the post-meeting time frame encompasses the following tasks and activities (process action 422). The instructor can download the recording of the meeting. The recording can be edited if necessary for availability to be viewed asynchronously. The instructor can pull attendance data and testing scores for each attendee into a database application for course completion and tracking. The instructor can download meeting content and stores content on an internal training portal.

### 2.5 Changing Scope Between the Main Room and Breakout Rooms

In one embodiment, a parent-child relationship is used with the Data Objects (DOs) of the present breakout room technique in order to change the scope of the main meeting room to a breakout room and vise-versa. A parent-child relationship is a well known relationship in a hierarchical structure in which the parent is one level higher and directly associated with one or more children. A child is one level lower and must have one parent.

### 2.5.1 Terminology

The following terms are useful in describing the scoping of the main meeting room to a breakout room:
A scope is a named portion of the meeting's content. Clients can act upon scopes without having knowledge of the content in other scopes.
The global scope is defined as the union of all content in the meeting, across all scopes, and including content that is not affiliated with any particular scope. The global scope is conceptually the main room.
A scoped room is conceptually a subset of the content available in the main room, or it may have its own unique content which is not visible from the main room. If the presenter moves himself to a scoped room he will only be able to view the slide sets that are assigned to that room.
A feature that has different behavior when in different scopes is a scoped feature, e.g., slide viewing is a scoped feature. It is possible to create and view different slide sets from different scopes.
A DO that expresses a scoped feature will be called a scope-aware DO. Scope-aware DOs implement scoped features. A slide manager is a scope-aware DO that is partially responsible for implementing scoped slide viewing.
Scope-aware DOs implement scoped features using scoped children. These are DOs that implement a subset of the scope-aware DOs functionality within the context of their scoped data.
Scoped data is a subset of the data available to the scope-ware DO, used by scoped-children. A slide manager scope has a partial list of all the slide sets available to the slide manager DO.

### 2.5.2 Scope Manager

The scope manager is a server DO with matching client counterpart. Its purpose is to manage the creation and destruction of breakout rooms, to move users between various breakout rooms, and to notify interested parties of these changes. Internally the scope manager maintains a mapping of unique scope IDs and scope names. The scope manager provides an interface for adding listeners, so that other DO on the server can be made aware of changes. For example, when a presenter requests a new breakout room, the server will create a new random integer which becomes the scope ID for the new room, it then adds this scope ID and name (as specified by the client) to its internal map. The scope manager then notifies any listeners of the creation via an event that describes the change as an ‘add’, as well as including the scope name and ID.

The scope manager manages scope creation, destruction, naming, and any information pertinent to the management of scoped DO and their children. Scope-aware DOs will listen to scope creation and destruction events that are generated by the scope manager, and will create and destroy scoped children in response. Each scope-aware DO will implement its scoped children in a manner that is suitable to the implementation of that particular DO.

Each scope aware DO is responsible for adding itself to the scope manager's notification list and providing notification. The notification event will provide details such as scope added, deleted, collapsed (e.g., for saving content back to the main room if pertinent), restarted (for rooms persisted from previous meetings), modified (name changed), users scope changed, scoped session enabled or disabled and scope manager started (e.g., for use when reading persistent data, i.e. the scope manager is started to let me verify that my persistent data matches the scope managers view of scoped rooms). When the scope manager is started it will attempt to read this data and will create breakout rooms for each entry found. It will notify any listeners with the ‘restarted’ event which is a cue to them in case they have persistent data that should be restored to their child DO. For instance the slide manager DO stores a scope ID with each slide set it persists. On startup it can relate the data from a scoped slide set to the appropriate child DO. Any slide sets that do not have a corresponding DO will be moved to the main room (and the error will be logged). Any other DO that has persistent data relevant to scope information (such as the audio DO) can take the restart event as an ‘add’ event and simply recreate their internal scoped structure as needed.

### 2.6 Breakout Rooms

Additional information on setting up, using, managing and terminating breakout rooms, as well as exemplary user interfaces, are provided in the following paragraphs.

### 2.6.1 Setting up Breakout Rooms

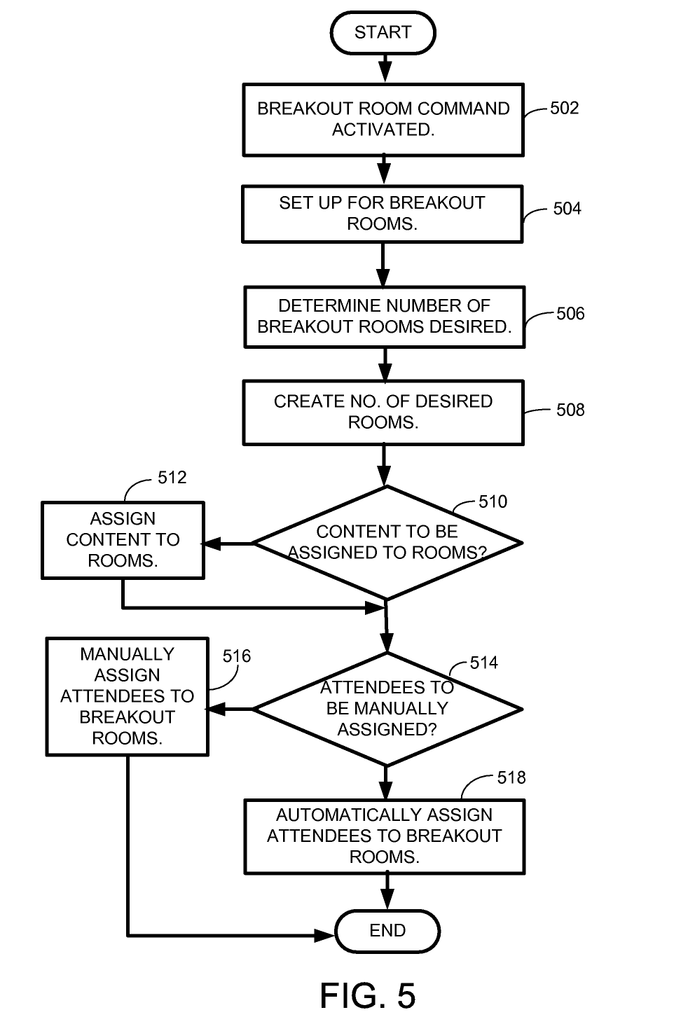

FIG. 5 is a flow diagram depicting the process of setting up breakout rooms in one exemplary embodiment of the present breakout room technique. In response to an activation of the breakout room initiation command, the breakout room setup dialog appears (process actions 502, 504). The desired number of breakout rooms are received (process action 506) and created (process action 508). A check is made to determine whether there is content (e.g., documents, slides, spreadsheets) to be assigned to the respective rooms (process actions 510, 512). Another check is made as to whether attendees are to be manually assigned to the breakout rooms (process action 514). If so, the instructor can manually assign the desired attendees to particular breakout rooms (process action 516). If the attendees are not to be manually assigned, automatic assignment of attendees to breakout rooms occurs (process action 518).

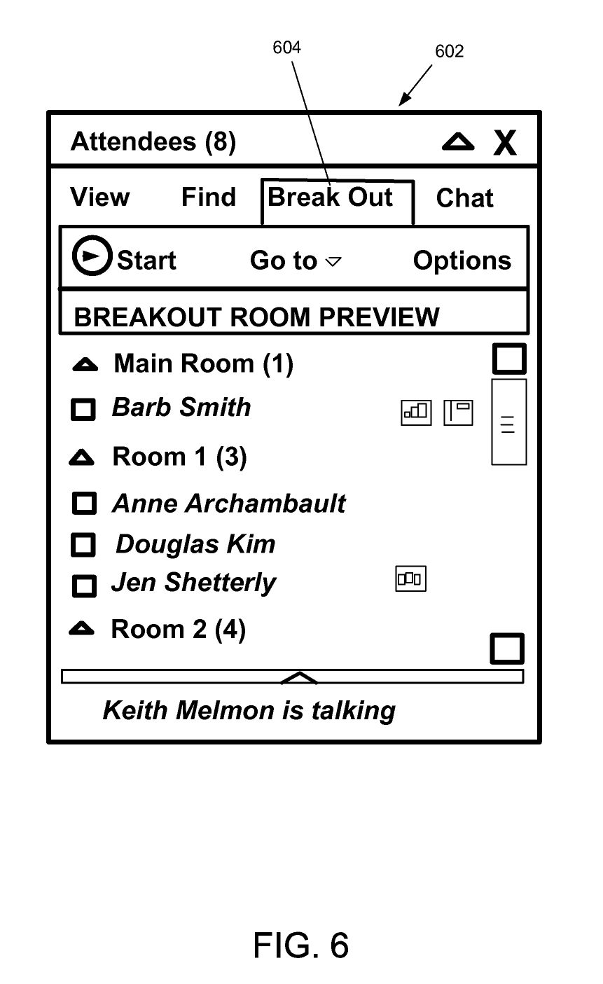

In one embodiment of the present breakout room technique, a breakout menu item is available on an attendee pane, shown in FIG. 6, as an instructor privilege. From the attendee pane 602, an instructor uses the breakout menu 604 for configuring, starting, managing and ending breakout rooms. A setup breakout rooms dialog appears when no breakout room configuration exists and the instructor activates the breakout menu 604.

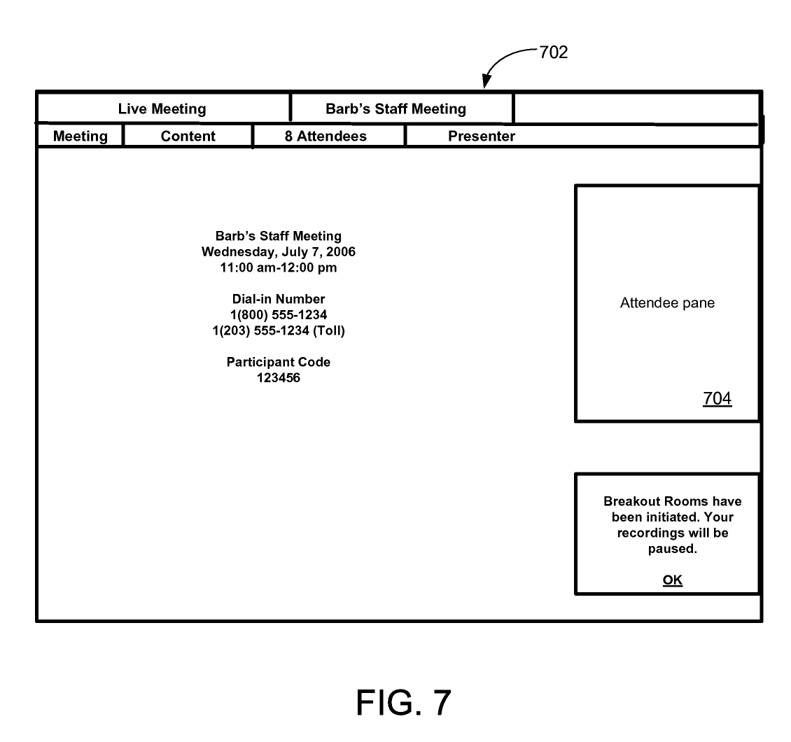

The attendee pane on the instructor's console, shown in FIG. 7, displays the “Breakout Room Setup” view once the rooms are created. The breakout room set up shows the attendees and content in the main room and each of the breakout rooms, as well as any content that is associated with each room. The attendees console remains unchanged during this phase where rooms are being setup by the instructor. In one embodiment, the breakout menu may have toggle behavior and shows or hides the control panel for breakout rooms.

In one exemplary working embodiment, the main room is always shown at the top, followed by the breakout rooms in alphabetical order. In another exemplary embodiment, whenever a breakout room is empty, a default helpful message is shown within that room. In one embodiment, when rooms are created, the present breakout room technique only shows one room expanded with the helpful text and the other rooms are in the collapsed state.

### 2.6.2 Assignment to Breakout Rooms

As stated previously, the following items are some of the features of assignments to breakout rooms employed in one exemplary embodiment of the present breakout room technique. A user can join a meeting by clicking on a link that they were sent in an email to join the meeting and then from within the meeting click on another link and to join the audio portion of the meeting. Such a user has both their meeting and audio reconciled. Alternatively a user can join the audio by directly dialing the number on a telephone keypad. Doing so does not allow the user to tie the meeting with the audio to represent the person as one single person. In these cases it is said that the user in not reconciled for their audio portion. In one embodiment assignment of attendees to breakout rooms is automatic by default. In the PSTN case, only reconciled users are assigned to breakout rooms. All others are left in the main room. The presenter can ask users to reconcile. Non-reconciled users can be manually moved (audio or data) to breakout rooms at the discretion of the presenter. Attendees are assigned to breakout rooms except if they have been moved back to the main room by the presenter. It should be noted that attendees and presenters cannot be present in two rooms at the same time. Also, presenters are not assigned to rooms automatically by default. They remain in the main room, which is not designed to be used as a breakout room. If manual assignment is selected, empty rooms are created. In one embodiment, manual assignment is done using drag and drop or by selecting attendees using the right click menu.

### 2.6.2.1 Automatic Assignment

In one embodiment, the default assignment is “automatic”. In this embodiment, attendees are randomly assigned to room based on either the number of breakout rooms selected or the maximum limit per breakout room. Attendees assigned to breakout rooms are sorted in alphabetical order by default. Individual attendees are not able to move to a breakout room by themselves. Assignment is solely an instructor privilege.

Automatic assignment triggers once breakout rooms are setup. Thereafter, in one embodiment, any attendee joining the meeting will be assigned to a room based on the setup parameters. Automatic assignment does not happen when breakout rooms are in session—new attendees joining the meeting join the main room. In one embodiment, when automatic assignment has been turned on, attendees are assigned to rooms at any time they join the meeting except when the rooms are in session. For example, when rooms have been setup and are being re-used for another instance of the meeting, new attendees joining the meeting are assigned automatically to the rooms they were in during the previous instance of the meeting.

### 2.6.2.2 Manual Assign—Drag and Drop

In one embodiment, if manual assignment is selected, then empty rooms are created. The instructor can select one or multiple attendees and drag and drop them to a breakout room. In one embodiment, drop targets (e.g., attendees to be moved into a breakout room) are shown with a line indicator and can be dropped anywhere on or below the room header. A Right Click menu is also available for assignment to a room. The menu is disabled if breakout rooms are not setup.

### 2.6.3 Maximum Limit for Breakout Rooms

In one tested embodiment, the maximum number of breakout rooms that can be created in a single training session is limited to 15 (this limit is dependent on limits imposed for audio provisioning purposes), although other numbers could be used. The sum total of the number of participants in breakout rooms is typically less than or equal to the original number of participants in the main room. Limits for breakout rooms at set up time are only used as a guideline for allocation at the time of room creation. At a later stage an instructor can assign additional attendees to a room that exceeds the original set up number.

### 2.6.4 Renaming Breakout Rooms

In one embodiment, the default name for breakout rooms is Breakout Room 1, 2, 3 . . . . to a maximum of 15. An instructor can double click on a room name to edit the name of the room.

### 2.6.5 Assigning Content to Breakout Rooms

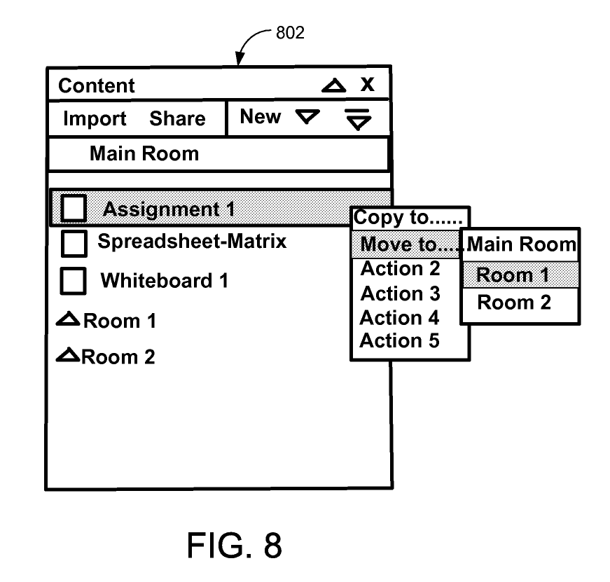

When breakout rooms are first created the rooms are empty and have no content associated with them. The instructor can assign content to the breakout rooms in the content pane by selecting single/multiple documents and dragging them to the breakout room using the right click menu. This will create copies of the document within the breakout room. Alternately, the instructor can move or copy content to all breakout rooms. In one embodiment, the menu to move content to rooms is disabled if breakout rooms are not setup. The content pane, 802, is shown in FIG. 8, is visible to attendees if they are enabled to see it. In one embodiment attendees see the scoped view of the content in any room they are in including the main room. Presenters see the hierarchical content view from all rooms.

### 2.6.6 Audio Setup for Breakout Rooms

Audio preferences for the main room are used for provisioning audio for breakout rooms. No specific audio setup is required for breakout rooms. In one embodiment, two audio options are available for seamless audio integration with breakout rooms. The first is 2-way VOIP where the main room and breakout rooms use this as their default audio channel. The second mode is PSTN sub conferencing wherein the participants in the main room and breakout rooms select an audio provider from the list of providers that also support sub-conferencing for their account. In one embodiment, PSTN sub-conferencing is the default audio channel for all rooms. VOIP can also be used as the audio solution for breakout rooms.

### 2.6.7 Account Level Settings

In one embodiment, breakout rooms have an account level license setting. If the user has the license to use breakout rooms, that functionality will be available to the users.

### 2.6.8 Launching Breakout Rooms

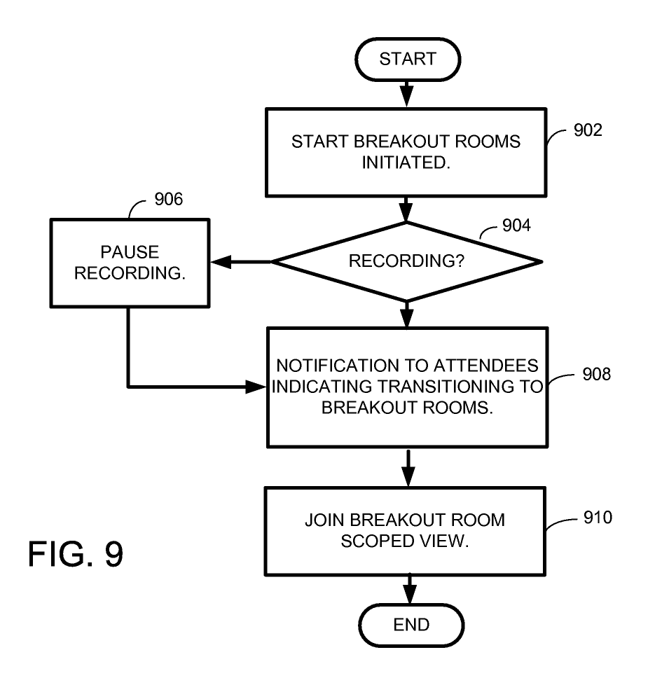

FIG. 9 shows a flow chart where breakout rooms are launched (as opposed to set up). The key points and commands for launching breakout rooms in one embodiment are as follows. Executing the Start Breakout rooms command, as shown in process action 902, moves all participants to a breakout room with audio. Recording, if activated for the main room, is paused (process actions 904, 906). The attendees are given a notification that they are transitioning to the breakout room (process action 908), and then they will join the breakout room in a scoped view (910). Any presenter manually assigned to a room will move to a breakout room when started. The Stop Breakout rooms command moves participants back to the main room from a breakout room with audio. Attendees cannot move back and forth between main room and their breakout room by themselves. However, presenters can move between rooms. Attendees cannot choose their own room. Assignment of attendees to a breakout room is done by the instructor. Once breakout rooms are set up, the instructor sees the breakout room control panel on the console. The start action moves all participants into their assigned breakout room. Unassigned attendees will continue to remain in the main room.

### 2.6.9 Attendee Permissions within Breakout Rooms

Attendees have certain attendee privileges turned on by default while in breakout rooms. In one embodiment, attendees can upload content in various formats (for example, slides, document imaging, video, flash, audio) and can also share applications. They can enter text and access a whiteboard, web slides and polling slides. They can also print to PDF, enter annotations, chat, participate in Q&A sessions and transfer files. They can send and receive notes (shared notes have global behavior; they are visible in main room and to all breakout rooms based on attendee permissions). They can also raise their hand and access audio controls. All other permission settings cascade from the main room to the breakout room or else are not available in the breakout room. The attendee permissions dialog is disabled from the console when breakout rooms are in session. In one embodiment, once breakout rooms are ended, all permissions revert back to the original permissions as set in the main room.

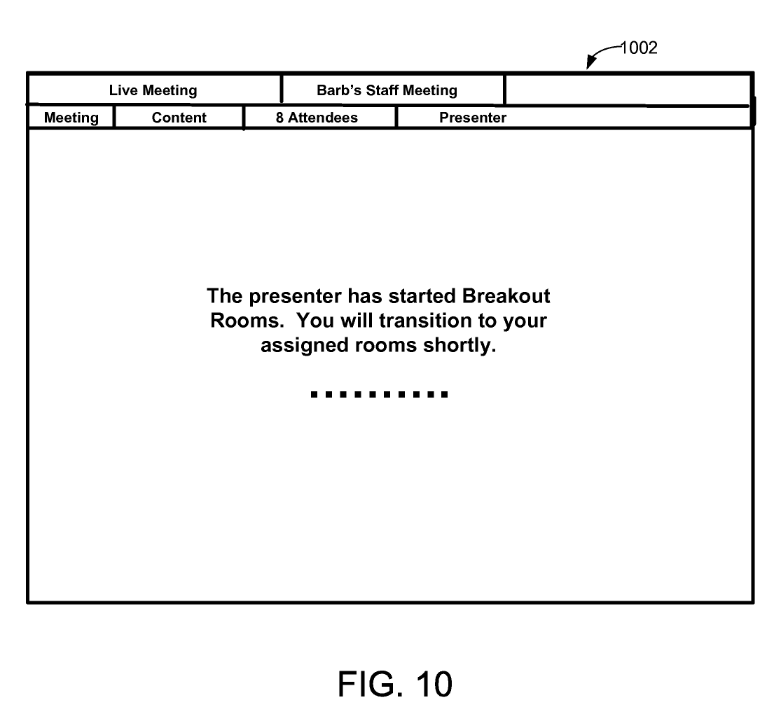

In one embodiment, shown in FIG. 10, a transition screen 1002 is displayed for approximately 5 seconds (though other durations could be used) before transitioning attendees to a breakout room. For example, in one version, the attendee display changes in place and the attendee see the transition page and are moved to the breakout room. The attendee pane is scoped down to indicate only those participants in that room and always shows the list of instructors irrespective of their room location. The resource pane is scoped to show only those resources that are available to this room. In one embodiment, the attendee pane and resource pane are shown as default when breakout rooms are started. As part of the transition to breakout rooms, existing chat sessions, Q&A, shared notes continue to be available to the attendee from within the breakout room if they were available in the main room.

When no content has been selected, in one embodiment, the attendee sees the name of the breakout room and the attendee and content panes as the default view. In all other cases, the last selected content will show up in the content viewing area with the attendee and content panes visible. In one embodiment, when an instructor joins a specific breakout room, the status area displays the following message “An instructor has joined your breakout room”.

### 2.6.10 Managing Breakout Rooms

In one embodiment, only instructors have the ability to manage breakout rooms.

### 2.6.10.1 Add Breakout Room

In one embodiment, selecting the add breakout room action creates a single empty room. No user assignment is made. The instructor is required to make a manual assignment to the room. If room was added while breakout rooms are in progress, any assignment of attendees into the room will trigger the attendee to be launched and joined to that specific room. In one embodiment, one can only add a breakout room if the maximum number of breakout rooms allowed is not reached. If it has been reached this option is grayed out.

### 2.6.10.2 Delete Contents of all Breakout Rooms

In one embodiment, the Delete Contents of All Breakout Rooms action deletes all content from each breakout room. It does not delete the room itself. In one embodiment, the action is available only when breakout rooms are not in session.

### 2.6.10.3 Delete all Breakout Rooms

In one embodiment, the Delete All Breakout Rooms action deletes all breakout rooms and their associated content. The action is only available when breakout rooms are not in session. When the rooms are deleted, the control panel is no longer available. The breakout room menu from the attendee pane allows for the Set up option. Individual breakout rooms cannot be deleted.

### 2.6.11 Within Breakout Rooms

In one embodiment, some capabilities are only available from the main room and are unavailable from breakout rooms. They are grayed out from the UI of attendees. These include recording, the ability to exit and end a breakout room session, modifying attendee privileges, sending invites from breakout rooms, video, slide cycling and setting attendee permissions.

### 2.6.11.1 Attendee View of Console within Breakout Rooms.

In one embodiment, an attendee always sees scoped attendee and content panes in breakout rooms. In one embodiment, attendees see a list of presenters in attendee pane even though the presenter may not be in their room.

### 2.6.11.2 Presenter View of Console While in Breakout Room

In one embodiment, the presenter sees the entire content pane showing content in all rooms while in a breakout room. While breakout rooms are in session, presenters can only perform functions (move, copy, delete, rename) on content that belongs to a room that they are not physically present in. They are not allowed to view the content that belongs to another room. In one embodiment the content pane will indicate a dotted box around content that cannot be viewed. The presenter sees the entire attendee pane showing all participants across all rooms when in a breakout room. When an instructor joins a breakout room, the instructor has presenter privilege and is identified in the attendee pane.

### 2.6.11.3 Content Pane

In one embodiment, the content pane is shown by default to attendees in a breakout room. Presenters see the full hierarchical content pane irrespective of whether they are in the main room or breakout room.

### 2.6.11.4 Manage Resources Pane

Using the Manage Resources Pane, attendees can manage resources only for the room that they are present in. Presenters can manage resources across all rooms.

### 2.6.11.5 Removing an Attendee from a Breakout Room

As the instructor in the breakout room, one can remove an attendee from the breakout room. The attendee is then ejected from the meeting.

### 2.6.11.6 Q&A from Breakout Rooms

In one embodiment, a Q&A feature in the main room is visible to all breakout rooms by default. If the instructor has disabled Q&A from the main room then this functionality is not available to the breakout rooms. The Q&A capability has a global scope and is available to all participants from any room. Attendees may ask public or private questions. The instructor can reply to the question and post privately or publicly. Public responses are displayed to all rooms.

### 2.6.11.7 Chat from Breakout Rooms

In one embodiment, chat is enabled by default in all breakout rooms. If chat is disabled in the main room then the chat is unavailable for the breakout sessions. Chat can be conducted between attendees and instructors in any room. It can also be conducted between attendees within a breakout room. In one embodiment, attendees are not able to chat with other attendees from other rooms. If a chat conversation is ongoing while in the main room, and breakout rooms are initiated, the chat conversation persists and is available to the user in the new breakout rooms. In one embodiment, if the chat window is closed, the attendee is limited to chat with only those participants visible in the scoped attendee list of the breakout room.

### 2.6.11.8 Audio

Audio controls are available in breakout rooms. The attendees can mute themselves and this state is preserved. A presenter can “Mute All” or mute an individual attendee. This overrides any mute/unmute action that an individual attendee may have initiated. In one embodiment, Mute All is global. When a presenter initiates a Mute All, it applies to all attendees in the conference.

### 2.6.11.9 Recordings

In one embodiment, recordings within breakout room sessions are disabled. The main room recording is set to the pause state when breakout rooms are active. The instructor sees a notification on the console. In one embodiment of the breakout room technique, an instructor is not able to resume, stop or publish a recording in the main room when breakout rooms are active. When breakout rooms are stopped and attendees are returned back to the main room, the presenter receives a notification to resume or stop the recording. On resume, normal recording controls are now available to the instructor in the main room. In another embodiment if client side recording is used then the user's recording continues through their breakout room session, while if server-side recording is utilized then the recording is paused (and later resumed) when breakout rooms are in session.

### 2.6.11.10 Handling NewAttendees when Breakout Rooms are in Session

In one embodiment, attendees join the main room if allowed by the instructor. No automatic assignment to rooms of new attendees takes place. That is, the instructor must manually move them to a breakout room. To do this the instructor may drag and drop attendees into the breakout room sessions. The instructor may add a breakout room and assign attendees to the room. If breakout rooms are active, then on assignment to a room, an attendee launches into that breakout room. In one embodiment, accidental disconnect from a breakout room only allows the attendee to join the main room.

### 2.6.11.11 Roaming Between Rooms

In one embodiment of the breakout room technique, only instructors have the privilege to walk between rooms. Instructors have the “Go To Room” menu option in the breakout room control of their console. Instructors can walk between the main room to a breakout room and vice versa. Instructors can also walk between breakout rooms. In one embodiment, when an instructor visits a breakout room they have full instructor privileges and are identified in the attendee list as an instructor. Joining any room automatically provisions the audio for that room for the instructor. The instructor has full visibility of who has raised their hand seeking help from any of the rooms. The instructor can chat or respond to Q&A from any of the rooms that he may be visiting.

### 2.6.11.12 Returning Back to Main Room

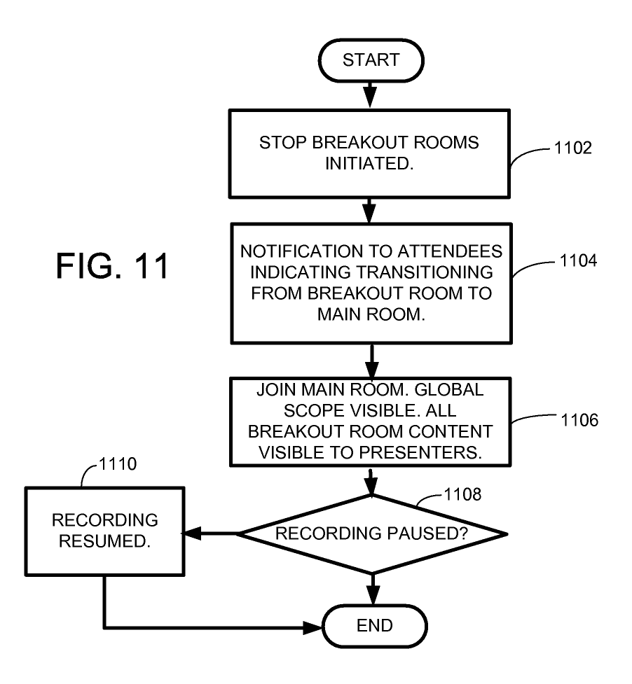

In one embodiment, the breakout rooms are stopped and attendees are brought into the main room when the stop command is issued. As shown in FIG. 11, process actions 1102 and 1104, when the stop breakout rooms command is initiated, the attendees are provided a notification indicating that the instructor has ended breakout rooms. The attendee display transitions in place and joins the attendee to the main room and automatically provisions the audio (process action 1106). Individual attendees cannot end a breakout room session or return to the main room. Only the instructor can stop breakout room sessions to returns student to the main room. The instructor cannot individually select a breakout room session and end it. Attendees see the scoped content and attendee panes in the main room. If recording was paused in the main room, recording is resumed (process actions 1108, 1110).

### 2.6.12 Assigning Content for Main Room Review

In one embodiment, content that needs to be reviewed from breakout sessions is selected by the instructor from the resource pane. Instructors can access any content from any of the rooms and show it in the main room. If they want a particular attendee to drive the content, the attendee can be promoted to a presenter or granted additional attendee privileges. No special action is needed by attendees to move content back to the main room, since this is always available to the presenter. If an attendee is promoted to presenter or granted additional attendee privileges to view content, then their resource pane will be similar to that of the instructor and they will have full view of the main room and breakout room resources. Content is associated by breakout room and not by any attendee.

### 2.6.13 Re-using Breakout Rooms

An instructor may conduct several breakout room sessions during a training session. These breakout rooms exist with the meeting and use the last known room assignment configuration. If new attendees join the meeting, they will be assigned to a room if the automatic assignment option is selected. Automatic assignment does not happen to attendees joining the meeting when breakout rooms are in session. If the meeting is re-used at a later point of time, then all new attendees will be assigned to a room if automatic assignment is selected. Content within breakout rooms persists just like it does in the main room. In one embodiment, content is deleted only if the instructor explicitly deletes it or content expiration policy is being enforced. The Reset All command allows cleaning up of content from breakout rooms.

### 2.6.14 Via Web Front End

Instructors scheduling their training event are able to specify the number of breakout rooms that should be configured for the event and the minimum number of participants per room. The instructor can also specify whether participants are automatically assigned to rooms or not. The default is always to automatically assign participants to rooms. The rooms are created when the Start Breakout room action is initiated and the participants are divided up based on the set up information.

### 2.6.15 Breakout Room Timer

Instructors can set up a time limit for how long the breakout room session exists. The breakout room rolls back to the main room at the designated time limit.

### 2.6.16 Raising Your Hand

Every attendee has the ability to call for help or seek their instructor's attention by raising their hand. This raised hand indicator is shown in the communications toolbar on the console. Each hand raised is queued up in the order it was received. The instructor is always able to access the communication toolbar in order to answer questions or service a raised hand. The instructor has the ability from the communications manager to clear a raised hand or question. Instructors may provide assistance to the attendee that has raised their hand by either conducting a 1:1 text chat or by joining the breakout room. This allows the instructor to look at contents of breakout room as well as join the audio conversation.

### 2.6.17 Send Announcement

The instructor can send an announcement text message to all participants and is visible on their console screens as a notification. All presenters and attendees in all rooms will see this broadcast message. Example: You have 10 minutes remaining to finish your breakout rooms.

### 2.7 Video

In one embodiment, if video is enabled as an attendee privilege in the main room then it will be enabled in the breakout room. When the breakout rooms are launched, video is available in a breakout room. Individual attendees in the breakout room can access a video pane, select a video source and choose whose video is seen during the breakout room session. They can also switch between other attendees. In the case where the main room has a VOIP audio configuration, when breakout rooms are launched, video is available in the breakout rooms. Individual attendees in the breakout rooms can access the video pane and select the video source and choose either the chair control or dominant speaker mode. If the chair control mode is selected then a specific attendee chosen from the list available will be seen. If dominant speaker mode is selected the video will dynamically switch between the users speaking on the VOIP channel. Typically only one speaker is shown at a time.

In one embodiment of the present breakout room technique the focus is on E-Learning. However, in other embodiments the present breakout room technique can also be used for electronic marketing or E-marketing.

It should also be noted that any or all of the aforementioned alternate embodiments may be used in any combination desired to form additional hybrid embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. In a computer system having a graphical user interface including a display and a user interface selection device, a method of provisioning attendees at a meeting conducted over a computer network into sub-meetings, comprising the steps of:
displaying a menu on an attendee pane on the display, wherein the attendee pane lists all of the attendees at the meeting, and wherein the menu on the attendee pane comprises a breakout room menu entry for provisioning the attendees into sub-meetings; and
receiving a menu entry selection signal indicative of the user interface selection device pointing at the breakout room menu entry on the display, and, in response to the selection signal, displaying a notice on the display that attendees will be transitioning from the meeting to sub-meetings.

2. The method of claim 1 further comprising the step of:
provisioning the list of all the attendees at the meeting into sub-meetings in the attendee pane on the display.

3. The method of claim 1 wherein video corresponding to a meeting attendee is available and wherein the video corresponding to the meeting attendee is provisioned into the sub-meeting into which the meeting attending is assigned.

4. The method of claim 1 wherein the attendee pane further comprises meeting content associated with the meeting displayed in the attendee pane on the display, further comprising the step of:
provisioning the meeting content to the sub-meetings.

5. The method of claim 1 wherein the meeting content provisioned to each sub-meeting is displayed on a content display pane on the display.

6. The method of claim 1 wherein the notice on the display is displayed for approximately five seconds.

7. The method of claim 1 wherein the attendees in the attendee pane can be dragged and dropped under headings defining the sub-meetings to provision the attendees into sub-meetings using the user interface selection device.

8. A computer-readable medium having computer-executable instructions for performing the method recited in claim 1.

9. A graphical user interface for conducting a web-conference over a computer network, comprising:
a display pane showing a list of meeting attendees;
a transition screen shown while the meeting attendees are divided into sub-meetings; and
a display pane showing the meeting attendees divided into sub-meetings.

10. The graphical user interface of claim 9 wherein the display pane showing the list of meeting attendees further comprises a control to allow division of the meeting attendees into the sub-meetings.

11. The graphical user interface of claim 9 further comprising a content display pane showing meeting content for a meeting, wherein the content display pane shows the meeting content available in each sub-meeting.

12. The graphical user interface of claim 9 wherein at least one meeting attendee in a sub-meeting is identified as a presenter.

13. In a computer system having a graphical user interface including a display (226) and a user interface selection device, a method of provisioning attendees at sub-meetings conducted over a network into a single main meeting, comprising the steps of:
displaying a menu on an attendee pane on the display, wherein the attendee pane lists all of the attendees in sub-meetings, and wherein the menu on the attendee pane comprises an entry for grouping the attendees into a single main meeting; and
receiving a menu entry selection signal indicative of the user interface selection device pointing at the entry on the display, and, in response to the selection signal, displaying a notice on the display that attendees will be transitioning from the sub-meetings to the main meeting.

14. The computer system of claim 13 further comprising the step of:
transitioning the attendees from the sub-meetings to the main meeting by displaying the names of the attendees under a single main meeting heading in the attendee pane.
